(19) United States
(12) Patent Application Publication
(10) Pub. No.: US 2017/0160892 A1
(43) Pub. Date: Jun. 8, 2017

(54) INDIVIDUAL CUSTOMIZATION SYSTEM AND METHOD

(71) Applicants: Fu Tai Hua Industry (Shenzhen) Co., Ltd., Shenzhen (CN); HON HAI PRECISION INDUSTRY CO., LTD., New Taipei (TW)

(72) Inventors: XIN LU, Shenzhen (CN); HUAN-HUAN ZHANG, Shenzhen (CN); XUE-SHUN LIU, Shenzhen (CN); YU-YONG ZHANG, Shenzhen (CN)

(21) Appl. No.: 15/048,153

(22) Filed: Feb. 19, 2016

(30) Foreign Application Priority Data
Dec. 3, 2015 (CN) 201510875687.8

(51) Int. Cl. G06F 3/0484; G06F 3/0482; H04L 12/26; H04L 29/08; G06F 17/30

(52) U.S. Cl. CPC G06F 3/0484; H04L 67/22; G06F 17/3051; H04L 43/16; G06F 3/0482

(57) ABSTRACT

An individualized or individual customization system includes a plurality of collecting terminals and a server coupled to the plurality of collecting terminals. The server obtains at least one related group within the plurality of collecting terminals and information as to demand management relevant to the at least one related group. The demand management information is analyzed to determine a triggering event and a corresponding triggering result and to monitor whether information collected by a collecting terminal is in accord with a triggering event. A triggering result corresponding to the trigger event is executed when the information collected by a collecting terminal is in accord with the triggering event. An individual customization method is also provided.

### FIELD

The subject matter herein generally relates to a personal preferences recognized by computer and a related method.

### BACKGROUND

Internet of Things (IoT) has evolved from an existing Ubiquitous Sensor Network (USN) or Machine to Machine (M2M) communication procedure. While M2M communication is primarily aimed at communication between communications equipment, for example, an end device and a person, IoT has enabled communications between things, generally visible to users, such as a telephone, a book, and a thermometer, and a person. For example, IoT may indicate a machine-and-space connecting network in which there are three distributed environmental elements, a person, a thing, and a service, and these elements can cooperatively establish intelligent relationships, such as sensing, networking, and information processing, without explicit intervention of the person.

### BRIEF DESCRIPTION OF THE DRAWINGS

Implementations of the present technology will now be described, by way of example only, with reference to the attached figures.

FIG. 1 is a schematic diagram of an example embodiment of a individual customization system.

FIG. 2 is a diagrammatic view of an example embodiment of the individual customization system of FIG. 1.

FIG. 3 is a schematic diagram of an example embodiment of a first user interface application of the individual customization system of FIG. 1.

FIG. 4 is a schematic diagram of an example embodiment of a second user interface application of the individual customization system of FIG. 2.

FIG. 5 is a flowchart of a personalized customization method using the individual customization system of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series, and the like. In general, the word “module”, as used herein, refers to logic embodied in hardware or firmware, or to a collection of software instructions, written in a programming language. The software instructions in the modules may be embedded in firmware, such as in an erasable programmable read-only memory (EPROM) device. The modules described herein may be implemented as either software and/or hardware modules and may be stored in any type of computer-readable medium or other storage device.

The present disclosure is described in relation to a individual customization system and a related method. The individual customization system includes a plurality of collecting terminals and a server coupled to the plurality of collecting terminals. The server is used to obtain at least one related group of the plurality of collecting terminals and information as to a demand management according to the at least one related group, analyze the demand management information to determine a triggering event and a triggering result to correspond to the triggering event, monitor for the collected information collected by a collecting terminal being in accord with the triggering event, and execute a triggering result accordingly. A personalized customization method is also provided.

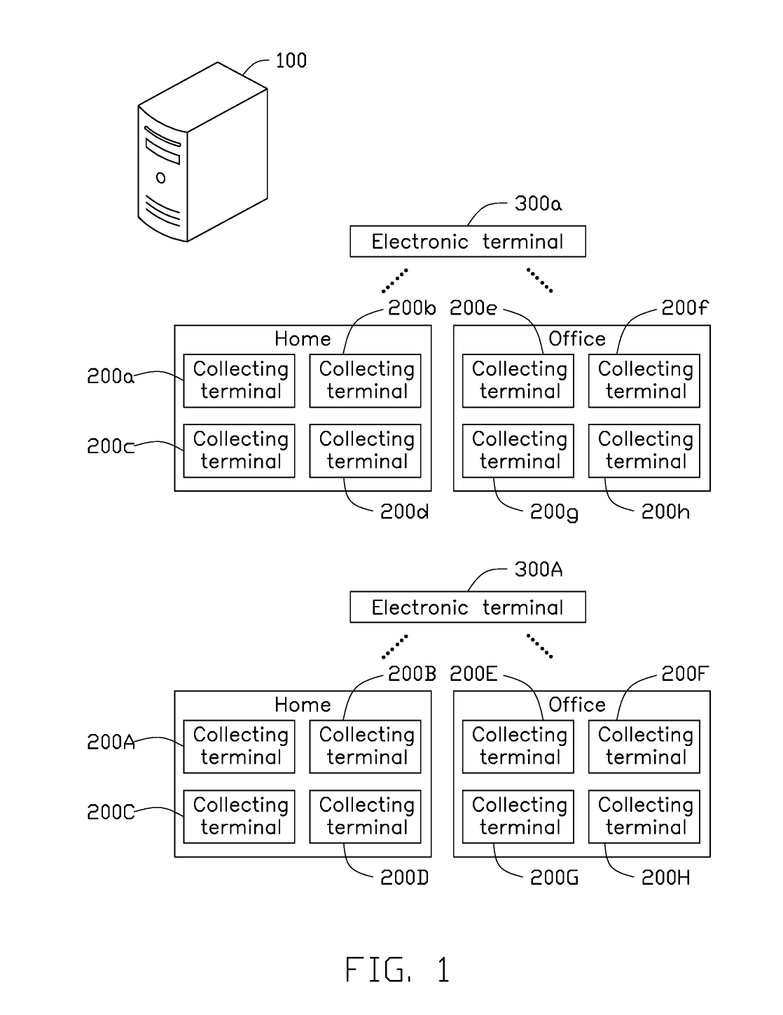

FIG. 1 illustrates an embodiment of a individual customization system 10 which can be applied to a server 100 connected with multiple collecting terminals 200A-200H, 200a-200h and multiple electronic terminals 300A, 300a.

The multiple collecting terminals 200A-200H, 200a-200h can be multiple terminals in a home for collecting information as to daily life, or can be multiple terminals in multiple homes for collecting similar information. The multiple electronic terminals 300A, 300a can be configured to add to or be set up with the multiple collecting terminals 200A-200H, 200a-200h. In at least one embodiment, the multiple collecting terminals 200A-200H, 200a-200h can be temperature sensors, cameras, humidity sensors, clocks, air-conditioning remote controls, or television remote controls. The multiple collecting terminals 200A-200H, 200a-200h also can be articles with electronic tags, such as clothes, desks, or key rings. The multiple electronic terminals 300A, 300a can be electronic devices, such as telephones, touch panels, or notebooks. The multiple electronic terminals 300A, 300a can obtain information from the server 100. In at least one embodiment, the multiple electronic terminals 300A, 300a also can be collecting terminals configured to collect information, such as geographic locations of the electronic terminals 300A, 300a.

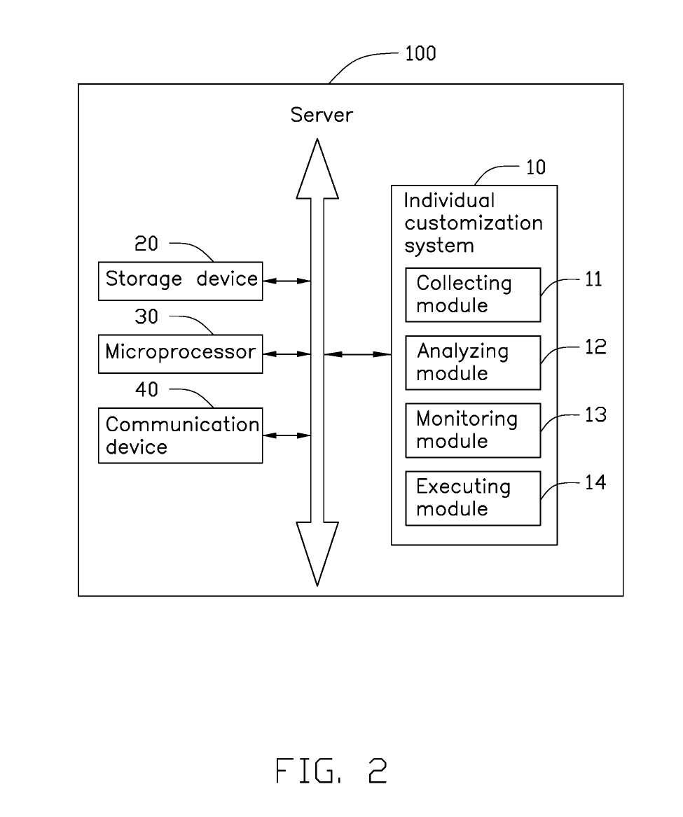

FIG. 2 illustrates an embodiment of the server 100. The server 100 can include a storage device 20, a microprocessor 30, and a communication device 40. In at least one embodiment, the storage device 20 can be a random access memory (RAM) for temporary storage of information, and/or a read only memory (ROM) for permanent storage of information. In at least one embodiment, the storage device 20 also can be an external storage device, such as an external hard disk or a storage card. The microprocessor 30 is coupled to the storage device 20 and the communications device 40. The communications device 40 allows the multiple collecting terminals 200A-200H, 200a-200h to couple to the electronic terminals 300A, 300a. In at least one embodiment, the individual customization system 10 can be stored in the storage device 20 and executed by the microprocessor 30.

In at least one embodiment, the individual customization system 10 can include a module or multiple modules stored in the storage device 20 and executed by the microprocessor 30. For example, the individual customization system 10 can include a collecting module 11, an analyzing module 12, a monitoring module 13, and an executing module 14. In at least one embodiment, the collecting module 11, the analyzing module 12, the monitoring module 13, and the executing module 14 can be comprised of computerized instructions in the form of one or more computer-readable programs stored in the storage device 20 and executed by the microprocessor 30.

The collecting module 11 collect information from at least one related group and at least one demand corresponding to the at least one related group. In least one embodiment, each related group can include relevance and priorities as between multiple collecting terminals 200A-200H, 200a-200h.

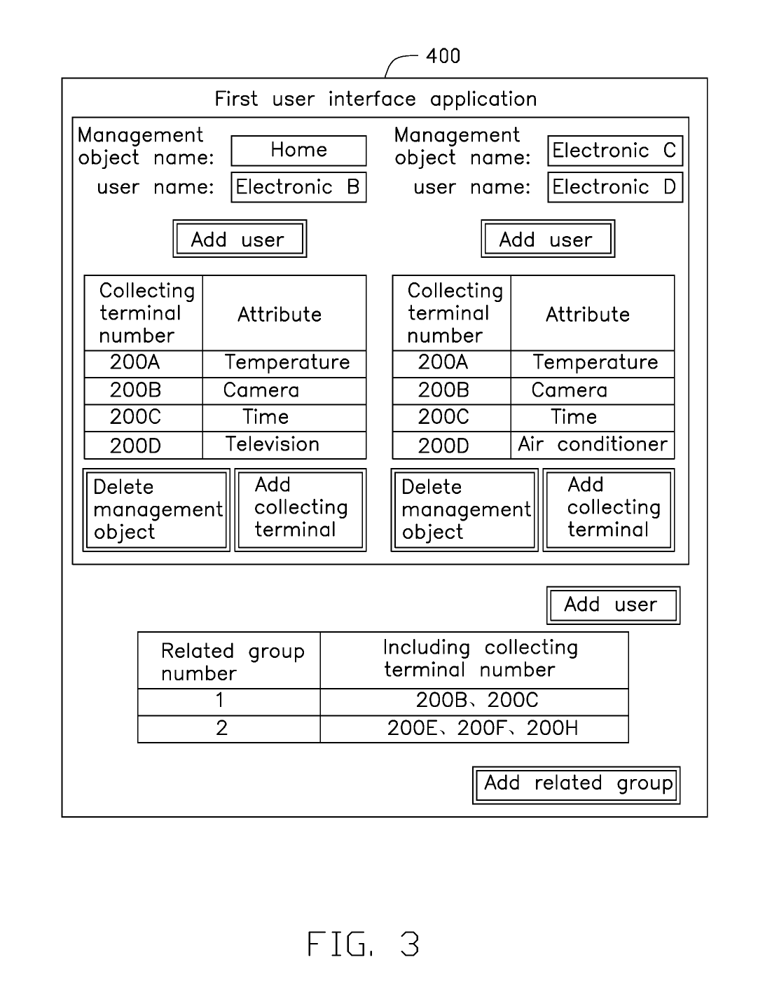

In at least one embodiment, the collecting module 11 can offer a first user interface application 400 (see FIG. 3) for adding multiple collecting terminals 200A-200H, 200a-200h and set the at least one related group according to relevance between multiple collecting terminals 200A-200H, 200a-200h. Each related group can include at least one event relevant to the related group or multiple collecting terminals related to the at least one event. In least one embodiment, the first user interface application 400 also can be used to set user permissions.

FIG. 3 illustrates an embodiment of the electronic terminals 300A, 300a. The first user interface application 400 can be configured for a user to add article, for example, home or office articles. The first user interface application 400 also can be used to set user permissions, for example, a user permission of the home is user B, and another or other users issuing home permissions may be user C and user D. In addition, the first user interface application 400 also can function as the collecting terminals at the home, that is, the collecting terminals 200A-200D. The collecting terminal in the office are the collecting terminals 200E-200H. The first user interface application 400 also can be set attributes of the collecting terminals 200A-200H and build at least related group according to the relevance between the multiple collecting terminals 200A-200H, 200a-200h.

In at least one embodiment, the collecting terminals 200A, 200E can be temperature sensors to obtain environmental temperature. The collecting terminals 200B, 200F can be cameras to capture images, the current image can include a person or things or purchasable goods, such as eggs. In at least one embodiment, when eggs are in the current image, the number of eggs can also be calculated. The collecting terminals 200C, 200G can be clocks to obtain a date and time. The collecting terminal 200D is a television remote control to obtain a state of a television, such as the television being turned on or turned off. In at least one embodiment, the colleting terminals can be added to and not be limited to the collecting terminals 200A-200H, 200a-200h. In at least one embodiment, a first related group (group 1) can include the related collecting terminals 200B, 200C, and the second related group (group 2) can include the related collecting terminals 200E, 200F, 200H.

In at least one embodiment, more related groups can be set between the multiple collecting terminals 200A-200H, 200a-200h by the first user interface application 400.

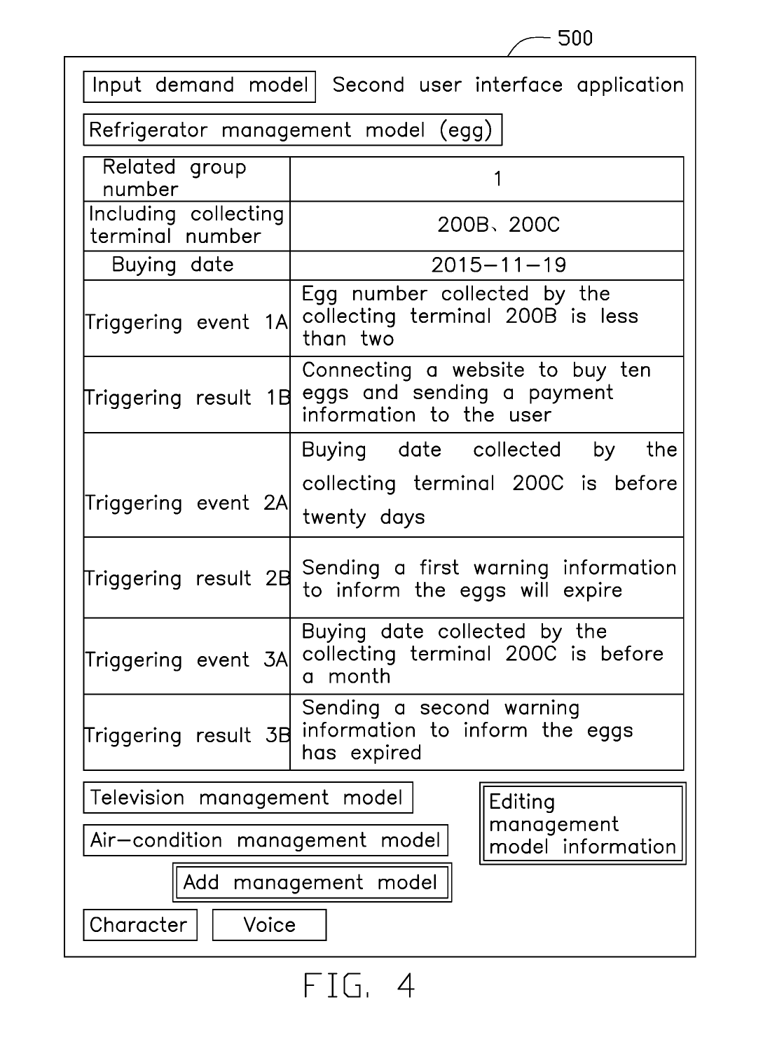

FIG. 4 illustrates an embodiment of a second user interface application 500 of the electronic terminals 300A, 300a. In at least one embodiment, the storage device 20 can store a plurality of management models. The collecting module 11 can present the second user interface application 500 on the electronic terminals 300A, 300a for a user to select a management model for the input of details of a demand. For example, when eggs in a refrigerator need to be managed, an egg management model can be added and selected. For example, a related group may include a collecting terminal number, an egg buying date, at least one triggering event, and at least one triggering result corresponding to the at least one triggering event. In at least one embodiment, the egg buying date can be obtained by a collecting terminal. In addition, the information base of a management model can be edited by the second user interface application 500, for example, adding or deleting a triggering event and a corresponding triggering result. In at least one embodiment, a new management model also can be added by the second user interface application 500 to be stored in the storage device 20. The new management model can be input in writing or orally.

The analyzing module 12 is configured to analyze a demand, to determine the triggering event and the triggering result corresponding to the triggering event.

The analyzing module 12 can be configured to obtain information as to demand management, to determine the triggering event and the corresponding triggering result set by the second user interface application 500. In at least one embodiment, when a management model is selected, the analyzing module 12 can obtain the triggering event and the corresponding triggering result of the management model. When information as to demand management is input by written or spoken means, the analyzing module 12 can obtain a keyword to determine the triggering event and the corresponding triggering result.

In at least one embodiment, FIG. 3 shows the working of an egg management model. The triggering events and the corresponding triggering results can include:

triggering event 1A: the number of eggs collected by the collecting terminal 200B being less than two;

triggering event 1B: connecting to a web site to buy ten eggs and send payment information to the user;

triggering event 2A: buying date collected by the collecting terminal 200C is within twenty days ago;

triggering result 2B: sending a first warning as to future expiry date of the eggs;

triggering event 3A: buying date collected by the collecting terminal 200C is within 30 days ago;

triggering result 3B: sending a second warning to inform a user that expiry date of eggs has passed.

The monitoring module 13 can be configured to monitor whether information collected by a collecting terminal is in accord with a triggering event. If the information collected by a collecting terminal is in accord with a triggering event, the executing module 14 can execute a corresponding triggering result. For example, when information collected by the collecting terminal 200B shows that the number of eggs is less than two, then the information collected by a collecting terminal 200B is in accord with the triggering event 1A. The executing module 14 can thus execute the triggering event 1B “connect to a website to buy ten eggs and send payment information to the user.”

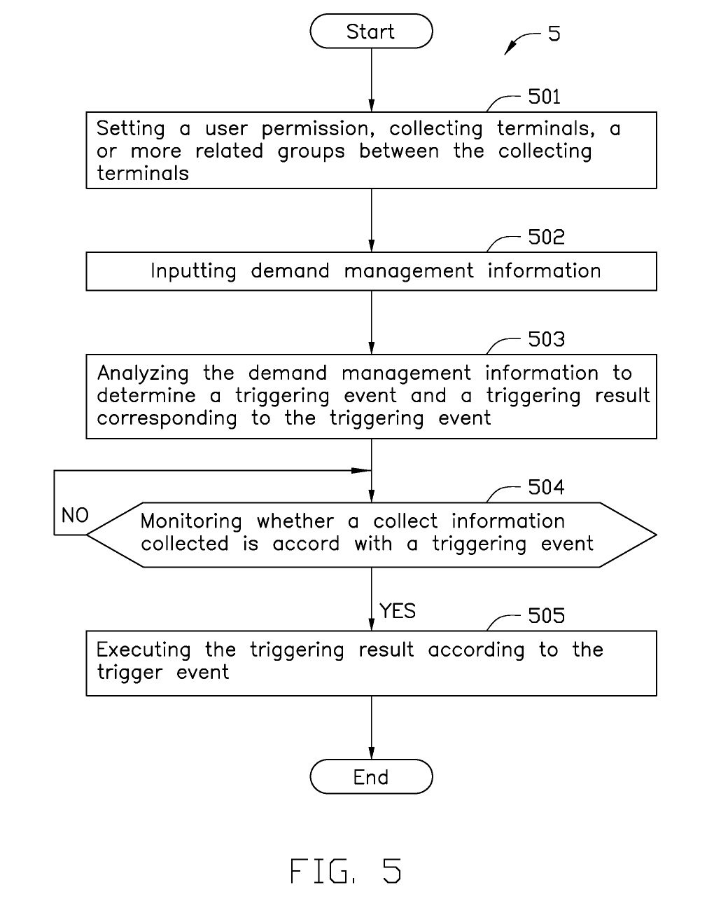

FIG. 5 shows a flowchart presented in accordance with an example embodiment. The example method (method 5) is provided by way of example, as there are a variety of ways to carry out the method. The method 5 described below can be carried out using the configurations illustrated in FIGS. 1-4, for example, and various elements of these figures are referenced in explaining method 5. Each block shown in FIG. 5 represents one or more processes, methods, or subroutines, carried out in the method 5. Additionally, the illustrated order of blocks is by example only and the order of the blocks can change. The method 5 can begin at block 501.

At block 501, setting a user permission, collecting terminals, setting up one or more related groups between the collecting terminals, via a first user interface application on an electronic terminal.

At block 502, inputting information as to demand management via a second user interface application on the electronic terminal.

At block 503, analyzing the demand management information to determine a triggering event and a corresponding triggering result.

At block 504, monitoring whether information collected by a collecting terminal is in accord with a triggering event; if yes, go on block 505, if no, go back to block 504.

At block 505, executing a triggering result according to a trigger event.

The embodiments shown and described above are only examples. Many details are often found in the art such as the other features of a individual customization system and a related method. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. An individual customization system comprising:
a plurality of collecting terminals; and
a server coupled to the plurality of collecting terminals and configured to:
obtain at least one related group of the plurality of collecting terminals;
obtain a demand management information according to the at least one related group;
analyze the demand management information to determine a triggering event and a triggering result corresponding to the triggering event;
monitor received collected information collected by a collecting terminal;
determine if the received collected information is in accordance with the triggering event; and
execute a triggering result according to the trigger event, when the collected information is in accordance with the triggering event.

2. The individual customization system of claim 1, further comprising an electronic terminal coupled to the server, wherein the electronic terminal is configured to set the at least one related group of the plurality of collecting terminals and a demand management information according to the at least one related group.

3. The individual customization system of claim 2, wherein the electronic terminal is also configured to set a user permission via a first user interface application.

4. The individual customization system of claim 2, wherein the electronic terminal is also configured to input the demand management information by character or voice.

5. The individual customization system of claim 2, wherein the server comprises a storage device, a plurality of demand management models is stored in the storage device, the electronic terminal is also configured to select one of the plurality of demand management models to input the demand management information.

6. An individual customization method, comprising:
(a) obtaining at least one related group of the plurality of collecting terminals and a demand management information according to the at least one related group;
(b) analyzing the demand management information to determine a triggering event and a triggering result corresponding to the triggering event;
(c) monitoring received collected information collected by a collecting terminal;
(d) determining if the received collected information is in accordance with the triggering event; and
(e) executing a triggering result according to the trigger event, when the collect information is accord with the triggering event.

7. The individual customization method of claim 6, wherein before the step (a) comprises following step (e): set the at least one related group of the plurality of collecting terminals and a demand management information according to the at least one related group.

8. The individual customization method of claim 7, wherein the step (e) comprises following step (e1): setting a user permission via a first user interface application.

9. The individual customization method of claim 7, wherein before the step (b) comprises following step (b1): inputting the demand management information by character or voice.

10. The individual customization method of claim 9, wherein before the step (b) comprises following step (b2): storing the plurality of demand management models in a storage device, and selecting one of the plurality of demand management models to input the demand management information.
